(19) United States
(12) Patent Application Publication
(10) Pub. No.: US 2014/0272098 A1
(43) Pub. Date: Sep. 18, 2014

(54) PROCESS FOR MANUFACTURING NANOPARTICLES IN A CONCENTRATED SLURRY

(71) Applicant: NORDKALK OY AB, Pargas (FI)

(72) Inventors: Mathias Snare, Pargas (FI); Artem Vochev, Pargas (FI); Juuso Hakala, Pargas (FI)

(73) Assignee: NORDKALK OY AB, Pargas (FI)

(21) Appl. No.: 13/826,849

(22) Filed: Mar. 14, 2013

(30) Foreign Application Priority Data
Mar. 13, 2013 (FI) 20135243

(51) Int. Cl. C09D 133/08; C09J 133/08

(52) U.S. Cl. CPC C09D 133/08; C09J 133/08
USPC 427/2.1; 523/300; 524/425; 427/600

(57) ABSTRACT

The present invention concerns a process for manufacturing nanoparticles in a slurry based on an aqueous solvent by treating said inorganic particles or their agglomerates in said solvent at a solids content of 30-75w-%, by adding dispersing agent(s) and by carrying out ultrasonic treatment at an intensity of 5-1000 W/cm² on this concentrated slurry. Thereby, a homogenous consistent particle slurry is obtained.

### CROSS REFERENCE TO RELATED APPLICATION

Applicants hereby claim foreign priority benefits under U.S.C. §119 from Finnish Patent Application No. 20135243 filed on Mar. 13, 2013, the contents of which are incorporated by reference herein.

### BACKGROUND OF THE INVENTION

1. Field of the Invention

The present invention concerns a process for manufacturing nanoparticles in a concentrated aqueous slurry by dispersion of inorganic particle agglomerates. Further, the invention concerns the nanoparticle slurry obtained using said process, as well as the use of said slurry in coating and adhesive formulations.

2. Description of Related Art

Nanoparticle research is currently an area of intense scientific interest due to a wide variety of potential applications in biomedical, optical and electronic fields. Particularly their synthetic methods are being constantly developed, with an attempt to overcome problems, such as their uncontrolled agglomeration.

For example, nano-sized precipitated calcium carbonate (nano-PCC) is manufactured by forming slurries of nano PCC agglomerates whereafter mixing/dispersion and dewatering is performed. Deagglomeration of nanoagglomerates is, however, limited and achieving a particle size below 1000 nm, is highly energy intensive. Furthermore, the deagglomeration is generally performed in low solid concentrations but this scenario is both more energy intensive and the postprosessing dewatering stage becomes highly challenging.

There is a demand for an improved procedure, since this traditionally used alternative gives a slurry that still contains non-dispersed agglomerates, and since the mixing according to this alternative requires excess intensity due to inefficient dispersion and the large amounts of water present. Further, the traditional procedures have not been feasible for concentrating particles of a size below 700 nm.

US 2012098163 A1, in turn, concerns the preparation of nanocomposites, which include nanoparticles in polymer matrices. The preparation includes a stage of mixing to improve the dispersion of the nanoparticles.

However, the addition of supplementary components to the slurry can make it complex and difficult to handle, which might lead to inconsistencies.

### SUMMARY OF THE INVENTION

It is an object of the present invention to provide a novel process for manufacturing consistent nanoparticle slurries.

Particularly, it is an object of the invention to provide such a process suitable for use in manufacturing concentrated and consistent slurries of nano-PCC.

These and other objects, together with the advantages thereof over known processes, are achieved by the present invention, as hereinafter described and claimed.

Thus, the present invention concerns a process for manufacturing nanoparticles in a concentrated slurry based on an aqueous solvent by the efficient dispersion of inorganic particle agglomerates therein.

More specifically, the process of the present invention comprises treating said inorganic particles or their agglomerates in said aqueous solvent at a solids content of 30-75 w-% by adding dispersing agent(s) and by carrying out ultrasonic treatment at an intensity of 5-1000 W/cm² on the concentrated slurry, whereby a stabilized and dispersed concentrated slurry is obtained.

Considerable advantages are obtained by means of the invention. Thus, the present invention introduces nano-particles that can be evenly and efficiently dispersed in an aqueous slurry.

Due to this novel procedure, the content of the nanoparticles (i.e. their concentration in the slurry) can be high during the dispersion stage, thus providing the possibility of processing (by ultrasonification) slurries with high solids contents, i.e. smaller amounts of water, compared to prior procedures.

This obtained slurry containing dispersed particles can be used to manufacture end products, such as coatings and adhesives, with superior optical, mechanical and reological properties, such as high gloss, durability and hardness as well as scrub and scratch resistance even at high solid loadings of these materials.

Furthermore, the obtained slurry can be dried (e.g. using a spray dryer) and thereafter be used to manufacture end products, such as plastics, rubbers, coatings and adhesives

Next, the invention will be described more closely with reference to the attached drawings and a detailed description.

### BRIEF DESCRIPTION OF THE DRAWINGS

FIG. 1 illustrates the intensity needed for dispersing calcium carbonate agglomerates to nanoparticles in a solid content range of 40-50 w-%.

FIG. 2 illustrates the gloss 60° of satin type paints as a function of the content of PVC.

FIG. 3 illustrates the gloss 60° of semi-gloss type paints as a function of the content of PVC.

FIG. 4 illustrates the tensile strength of binders with varying amounts of nano PCC and conventional binders.

### DESCRIPTION OF EMBODIMENTS OF THE INVENTION

The present invention concerns a process for manufacturing nanoparticles using a slurry based on an aqueous solvent. In the process, inorganic particle agglomerates are dispersed into a consistent slurry. Particularly, said inorganic particles or their agglomerates are treated in said aqueous solvent at a solids content of 30-75 w-% by adding dispersing agent(s) and by carrying out ultrasonic treatment at an intensity of 5-1000 W/cm² on this concentrated slurry. Thus, the dispersing treatment is carried out on a concentrated slurry.

The used intensity is preferably 10 to 500 W/cm². The upper limits are set by the limitations of the current ultrasonic devices, whereas an intensity below 5 W/cm² has been discovered to leave some undispersed agglomerates. The particle size of the final dispersed nanoparticles depends on the used energy of the ultrasonic treatment. Thereby, a slurry containing the dispersed nanoparticles having a particle diameter of <1.5 μm is obtained, preferably a mean particle diameter of 50-500 nm, most suitably a mean particle diameter of below 200 nm.

The conditions during the dispersion treatment of the invention are preferably close to ambient conditions, with a particularly preferred temperature being 0-95° C., and a particularly preferred pressure being 0.5-50 bar depending on the intensity used.

The nanoparticles can be formed from various inorganic compounds, particularly those obtainable from mineral sources. Examples include particles of calcium carbonate, silicate or other minerals derivable from clay or mica, preferably being calcium carbonate, more preferably precipitated or ground calcium carbonate (PCC or GCC), and most suitably being PCC. These materials can contain traces of organic compounds, which can also be transferred to the nanoparticles used in the invention. Due to the negligible contents of these organic compounds, the material of the nano-particles is still referred to as inorganic. Generally, these compounds form agglomerates in aqueous solvents.

The term “nano-particle” is intended to include any particles having a mean particle diameter of less than 1 μm. In the present context, a particle diameter of 50-200 nm is preferred.

These nanoparticles are generally obtained by the dispersion of said agglomerates to separate these into smaller particles in a slurry. According to the present invention, said slurry contains dispersed inorganic nanoparticles in a content of 30-75 w-%, preferably 45-65 w-%, and most suitably 45-55 w-%, of the slurry, during the treatment, i.e. before any dilution.

The slurry is intended to include any aqueous dispersions or mixtures formed using solvents or solutions that are based on water and optionally one or more co-solvents, being either inorganic or organic solvents.

The slurry preferably contains additives, as the most important ones being dispersing agents. These can, however, include also conventional binders.

The dispersing agent(s) are used to facilitate the complete dispersion of the nanoparticles into a consistent homogeneous slurry. The dispersing agents can be selected from the group of surface-active polymers, such as polycarboxylates, polyacrylates, polyethers and fatty-acid derivatives or a mixture thereof. Their content is generally maintained at a level of 0.1-8 w-%, preferably 2-4 w-%.

Said dispersion agent(s) can be added to the slurry either on-site during the treatment of the present invention, or off-site before treatment, i.e. to the agglomerates.

Further, an optional drying step can be carried out after the ultrasonic dispersion treatment, in order to provide the nanoparticles, as such, with a dry-matter content of 75 to 100 w-%, preferably close to 100 w-% (with a limitation caused by the fact that not all water can be removed from the particles).

The final (possibly diluted) slurry, or the dried particles thereof, can be used, for example, to prepare a coating for any solid substrate or to prepare a paper coating, e.g. by mixing the slurry with optional further coating components, to form a coating mixture, and applying said coating mixture onto a surface of the substrate or the paper. The further coating components include one or more agents selected from the group of binders, dispersing agents, wetting agents, anti-foaming agents, viscosity modifiers and coalesents (film-forming agents).

The above described coatings can be applied on any surfaces, which generally are surfaces of solid products, such as concrete, plastic, glass or fibrous surfaces. However, it is preferred to use these coatings on fibrous solid products, such as paper, wood or furniture. The coating is preferably applied as a uniform coating on at least one surface of said product, whereby the coating will cover the entire surface. The application is then preferably followed by a step of drying to remove the solvent, or at least to remove excess solvent.

Alternatively, the final (possibly diluted) slurry, or the dried particles thereof, can be used, for example, to prepare an adhesive, plastic, rubber, plaster, mortar, concrete, or pharmaceutical or medical product.

The following non-limiting examples are intended merely to illustrate the advantages obtained with the embodiments of the present invention.

### Examples

### Example 1

An aqueous slurry of PCC agglomerates (d_{50%}=5 μm) was obtained from a carbonatization plant, the agglomerates containing 40 to 50 w-% of nano-sized calcium carbonate. A polyacrylate dispersant was added into a content of 3 w-% to the agglomerate slurry, and the slurry was subjected to ultrasonic treatment with the same specific energy input at an intensity between 50 and 300 W/cm2. The results of FIG. 1 shows stabilized and dispersed nanoparticle slurries with an average particle size below 200 nm.

### Example 2

The objective of this example was to demonstrate the difference between dispersed slurry of nano-sized calcium carbonate and ultrafine GCC. Coating was performed in a satin type of paint formulation. At reference point (PVC (Pigment volume concentration) 18%) titanium dioxide acts as an only pigment. Amount of titanium dioxide was kept constant and amount of binder and nano PCC or ultrafine GCC were variable quantities throughout the test. After the reference point, the PVC is increased by nano PCC or ultrafine GCC.

### Substances Tested:

1. Ultrafine GCC, average size 0.7 μm

2. Dispersed nano calcium carbonate, average size 200 nm

The results are shown in FIG. 2. As may be seen from the figure with increasing PVC the gloss of nano-sized calcium carbonate coatings stay above 20% and with ultrafine GCC gloss rapidly declines below 20%. It is caused by the fact that with nano-sized particles surfaces of coatings stay smoother and therefore they scatter less light than with ultrafine GCC.

### Example 3

The same method is used in this example as in Example 2, with the exception of the coating being performed in semi-gloss type of paint formulation. The results are shown in FIG. 3. As is evident from these results, gloss 60° maintains quite high despite of very high PVC levels.

### Example 4

The objective of this example was to demonstrate the tensile strength of coatings and adhesives. Tensile strength describes both binding to substrate and cohesion of polymer/filler matrix. It was performed by applying adhesives (Table 1) between two wood blocks and measuring the required amount of strength to separate them. Ultrafine GCC is used in a reference adhesive. Adhesives A and B were manufactured by mixing definite amounts of the reference adhesive without ultrafine GCC and a dispersed nano-sized calcium carbonate slurry.

TABLE 1

| | Ref. | A | B |
|---|---|---|---|
| Water (w-%) | 37.3% | 50.2% | 51.2% |
| CaCO₃ (w-%) | 18% | 19.9% | 24.4% |
| Binder + additives (w-%) | 44.7% | 29.9% | 24.4% |

As will emerge from Table 1 and the results of FIG. 4, adhesives A and B contain much more water and less binder than reference adhesive. However, the tensile strength and elongation is still maintained or even improved in adhesive B.

The patent is not limited to aforementioned examples. The range of particle size is affected by specific energy input used. Additionally, the level of gloss and mechanical properties are application specific and not restricted by the examples used.

What is claimed is:

1. A process for manufacturing nanoparticles in a slurry based on an aqueous solvent by dispersion of inorganic particle agglomerates, wherein treating said inorganic particles or their agglomerates in said aqueous solvent at a solids content of 30-75 w-% by adding dispersing agent(s) and by carrying out ultrasonic treatment at an intensity of 5-1000 W/cm² on the concentrated slurry, whereby a stabilized and dispersed concentrated slurry is obtained.

2. The process of claim 1, wherein using particles of calcium carbonate, silicate or other minerals derivable from clay or mica as the inorganic particles, preferably calcium carbonate, more preferably ground or precipitated calcium carbonate (GCC or PCC), most suitably PCC.

3. The process of claim 1, wherein using water, optionally mixed with one or more co-solvents, as the aqueous solvent, the co-solvent(s) being either inorganic or organic solvents.

4. The process of claim 1, wherein treating the inorganic particles or their agglomerates in said aqueous solvent at a solids content of 45-65 w-%.

5. The process of claim 1, wherein adding one or more dispersing agents selected from the group of surface-active polymers, such as polycarboxylates, polyacrylates, polyethers and fatty-acid derivatives or a mixture thereof.

6. The process of claim 1, wherein carrying out ultrasonic treatment at an intensity of 10-500 W/cm² on the concentrated slurry.

7. The process of claim 1, wherein maintaining the conditions during the treatment close to ambient conditions, with a particularly preferred temperature being 0-95° C., and a particularly preferred pressure being 0.5-50 bar.

8. A slurry of inorganic nanoparticles in an aqueous solvent, wherein it contains the dispersed nanoparticles having a mean particle diameter of about 200 nm.

9. The slurry of claim 8, wherein it has been formed using the process of treating said inorganic particles or their agglomerates in said aqueous solvent at a solids content of 30-75 w-% by adding dispersing agent(s) and by carrying out ultrasonic treatment at an intensity of 5-1000 W/cm² on the concentrated slurry, whereby a stabilized and dispersed concentrated slurry is obtained.

10. Use of the slurry of claim 8, or of the slurry manufactured by treating said inorganic particles or their agglomerates in said aqueous solvent at a solids content of 30-75 w-% by adding dispersing agent(s) and by carrying out ultrasonic treatment at an intensity of 5-1000 W/cm² on the concentrated slurry, whereby a stabilized and dispersed concentrated slurry is obtained, optionally in dried form, as a coating on a substrate.

11. The use of claim 10, wherein the substrate is a solid product, such as a concrete, plastic, glass or fibrous product, the fibrous product preferably being selected from paper, wood or furniture.

12. The use of claim 10, wherein the substrate is a paper or board substrate.

13. The use of claim 10, wherein one or more agents selected from the group of binders, dispersing agents, wetting agents, anti-foaming agents, viscosity modifiers and film-forming agents are used to form a coating mixture prior to application onto the substrate.

14. The use of claim 10, wherein the slurry, the dried particles or the coating mixture is applied on a surface of the substrate using a film applicator.

15. The use of claim 10, wherein a drying step is carried out after the slurry, the dried particles or the coating mixture has been applied onto a surface of the substrate.

16. Use of the slurry of claim 8, or of the slurry manufactured by treating said inorganic particles or their agglomerates in said aqueous solvent at a solids content of 30-75 w-% by adding dispersing agent(s) and by carrying out ultrasonic treatment at an intensity of 5-1000 W/cm² on the concentrated slurry, whereby a stabilized and dispersed concentrated slurry is obtained, optionally in dried form, in an adhesive, plastic, rubber, plaster, mortar, concrete, or pharmaceutical or medical product.

17. The process of claim 2 wherein using water, optionally mixed with one or more co-solvents, as the aqueous solvent, the co-solvent(s) being either inorganic or organic solvents.

18. The process of claim 2, wherein treating the inorganic particles or their agglomerates in said aqueous solvent at a solids content of 45-65 w-%.

19. The process of claim 3, wherein treating the inorganic particles or their agglomerates in said aqueous solvent at a solids content of 45-65 w-%.

20. The process of claim 2, wherein adding one or more dispersing agents selected from the group of surface-active polymers, such as polycarboxylates, polyacrylates, polyethers and fatty-acid derivatives or a mixture thereof.
